(19) United States
(12) Patent Application Publication
(10) Pub. No.: US 2009/0185203 A1
(43) Pub. Date: Jul. 23, 2009

(54) METHODS AND SYSTEMS FOR AUTOMATED LOAD BALANCING OF COLOR PRINT JOBS

(75) Inventors: Nicholas Paul Osadciw, Webster, NY (US); Michael E. Farrell, Webster, NY (US); Javier A. Morales, Irondequoit, NY (US)

Correspondence Address: PEPPER HAMILTON LLP, 500 GRANT STREET, ONE MELLON CENTER, 50TH FLOOR, PITTSBURGH, PA, 15219, US

(73) Assignee: XEROX CORPORATION, Norwalk, CT (US)

(21) Appl. No.: 12/016,397

(22) Filed: Jan. 18, 2008

(51) Int. Cl. G06K 15/00

(52) U.S. Cl. 358/1.9; 358/1.15

(57) ABSTRACT

Methods and systems for selecting a printing device are disclosed. A print job may be received. A computing device may produce a first color transformation for the print job using at least a color gamut error profile for a first printing device to determine a first value and a second color transformation for the print job using at least a color gamut error profile for a second printing device to determine a second value. One of the printing devices may be selected for the print job based on at least the first value and the second value. The print job may be transmitted to the selected printing device and printed using the selected printing device.

### BACKGROUND

The present disclosure generally relates to color print systems and methods for operating such systems. More specifically, the present disclosure relates to methods and systems for routing a print job to a printing device based on the color space of the print job and the color gamut of the printing device.

Conventionally, print operations printing a full range of colors have been performed using a four-color printing technology that uses three primary ink colors cyan, magenta, and yellow—plus black (abbreviated as CMYK). More recently, five or more color (“high fidelity”) printing technologies have been introduced to provide a larger and more vibrant color gamut. An exemplary high fidelity printing technology is Pantone's Hexachrome system, which adds orange and green to the traditional CMYK.

Color printing can also use “spot color” inks alone or in combination with one of the above described printing methods. Spot color inks are specific color formulations that are printed alone, rather than mixed to produce various hues and shades. The range of available spot color inks is nearly unlimited. Spot color inks can be used to print colors from subtle pastels to fluorescent greens and oranges to metallic silvers, golds and other finishes.

As digital color printing increasingly becomes a commodity, print shop operators and other print providers have sought to determine ways to grow revenue and reduce costs. One way to increase revenue is to perform print jobs having high fidelity color requirements. A print provider can usually charge a customer more for a high fidelity color print job because of the superior color rendition.

In order to reduce costs, print providers desire to minimize the use of high fidelity color printing devices, particularly 6+ color printing devices, whenever possible because of the increased operating costs over other printing devices. However, it is difficult to determine whether an incoming high fidelity print job will actually benefit from being printed on a 6 color printing device. In some cases, a high fidelity print job printed on a 6 color printing device will not look significantly better than the same print job printed on a 4 color or 5 color printing device. As such, potential profit is lost when the high fidelity print job is automatically processed using a 6 color printing device.

### SUMMARY

Before the present systems, devices and methods are described, it is to be understood that this disclosure is not limited to the particular systems, devices and methods described, as these may vary. It is also to be understood that the terminology used in the description is for the purpose of describing the particular versions or embodiments only, and is not intended to limit the scope.

It must also be noted that as used herein and in the appended claims, the singular forms “a,” “an,” and “the” include plural references unless the context clearly dictates otherwise. Thus, for example, reference to a “print job” is a reference to one or more print jobs and equivalents thereof known to those skilled in the art, and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments, the preferred methods, materials, and devices are now described. All publications mentioned herein are incorporated by reference. Nothing herein is to be construed as an admission that the embodiments described herein are not entitled to antedate such disclosure by virtue of prior invention. As used herein, the term “comprising” means “including, but not limited to.”

In an embodiment, a method of selecting a printing device may include receiving a print job, producing, by a computing device, a first color transformation for the print job using at least a color gamut error profile for a first printing device to determine a first value, producing, by the computing device, a second color transformation for the print job using at least a color gamut error profile for a second printing device to determine a second value, selecting one of the printing devices for the print job based on at least the first value and the second value, transmitting the print job to the selected printing device, and printing the print job using the selected printing device.

In an embodiment, a system for selecting a printing device may include a first printing device, a second printing device, a processor in communication with the first printing device and the second printing device, and a processor readable storage medium in communication with the processor. The processor readable storage medium may contain one or more programming instructions for receiving a print job, producing, by the processor, a first color transformation for the print job using at least a color gamut error profile for the first printing device to determine a first value, producing, by the processor, a second color transformation for the print job using at least a color gamut error profile for the second printing device to determine a second value, selecting one of the printing devices for the print job based on at least the first value and the second value, and transmitting the print job to the selected printing device.

In an embodiment, a method of selecting a printing device may include receiving a print job, and, for at least one page of the print job, producing, by a computing device, a first color transformation for the at least one page using at least a color gamut error profile for the first printing device to determine a first value, producing, by the computing device, a second color transformation for the at least one page using at least a color gamut error profile for the second printing device to determine a second value, selecting one of the printing devices for the at least one page based on at least the first value and the second value, transmitting the at least one page to the selected printing device; and printing the at least one page using the selected printing device.

In an embodiment, a system for selecting a printing device may include a first printing device, a second printing device, a processor in communication with the first printing device and the second printing device, and a processor readable storage medium in communication with the processor. The processor readable storage medium may contain one or more programming instructions for receiving a print job, and, for at least one page of the print job, producing, by the processor, a first color transformation for the at least one page using at least a color gamut error profile for the first printing device to determine a first value, producing, by the processor, a second color transformation for the at least one page using at least a color gamut error profile for the second printing device to determine a second value, selecting one of the printing devices for the at least one page based on at least the first value and the second value, and transmitting the at least one page to the selected printing device.

### BRIEF DESCRIPTION OF THE DRAWINGS

Aspects, features, benefits and advantages of the present invention will be apparent with regard to the following description and accompanying drawings, of which:

FIG. 1 depicts a flow diagram for an exemplary method of selecting a printing device for a print job according to an embodiment.

FIG. 2 depicts a flow diagram for an exemplary method of selecting a printing device for at least one page of a print job according to an embodiment.

FIG. 3 depicts a block diagram of an exemplary system for selecting a printing device for a print job or at least one page of a print job according to an embodiment.

FIG. 4 depicts a block diagram of an exemplary system that may be used to contain or implement program instructions for selecting a printing device for a print job or at least one page of a print job according to an embodiment.

### DETAILED DESCRIPTION

The following terms shall have, for the purposes of this applications the respective meanings set forth below.

A “job” refers to a logical unit of work that is to be completed for a customer. A job may include one or more print jobs from one or more customers. A production system may include a plurality of jobs. Although the disclosed embodiments pertain to a print shop and printing devices, the disclosed methods and systems can be applied to production systems in general.

A “print job” refers to a job processed in a print shop or other document production system. For example, a print job may include producing credit card statements corresponding to a certain credit card company, producing bank statements corresponding to a certain bank, printing a document, or the like. Although the disclosed embodiments pertain to print jobs, the disclosed methods and systems can be applied to jobs in general in other production environments, such as automotive manufacturing, semiconductor production and the like.

A “printing device” refers to an electronic device that is capable of receiving commands, printing text, vector graphics and/or images on a substrate and/or scanning a document. Print devices may include, but are not limited to, network printers, production printers, copiers, facsimile machines and/or other devices using ink or toner.

A “printing technology” refers to a set of inks or toners available to a printing device for printing a print job. Exemplary printing technologies include CMYK, Cyan-Magenta-Yellow-Black-Orange (CMYKO), Cyan-Magenta-Yellow-Black-Orange-Green (CMYKOG), Cyan-Light Cyan-Magenta-Light Magenta-Yellow-Black (CcMmYK), Cyan-Light Cyan-Magenta-Pink-Yellow-Black (CcMPYK), Cyan-Magenta-Yellow-Black-Orange-Violet (CMYKOV), Cyan-Magenta-Yellow-Black-Orange-Blue (CMYKOB), CMYK/RGB and the like. A “high fidelity printing technology” refers to a printing technology having a set of inks or toners having more than 4 colors, such as CMYKO.

A “gamut” or “color gamut” refers to a complete subset of colors that can be produced by a printing device or via a display device. A gamut or color gamut can alternately refer to a complete subset of colors that are present in a print job or a portion of a print job, such as a section, a page, an object or the like.

A “color profile” refers to a relationship between a color space and a well known standard. A color profile may be used to transform a color space for a print job, printing device (based on a particular printing technology) or display device into, for example, a standardized color space, or vice versa. A color profile may include a “source color profile” (which translates a color space to a standardized color space), a “destination color profile” (which translates the standardized color space to the color space) or both. In an embodiment, the standardized color space may be the color space defined by the International Color Consortium (ICC).

A “color gamut error profile” refers to a destination color profile that identifies a vector and/or a scalar value for each color in a color space corresponding to an amount by which the color is out-of-gamut for a corresponding printing device, display device or printing technology.

“Out-of-gamut” refers to a condition in which a color in a print job cannot be accurately represented using a printing device or a printing technology; that is, the color falls outside the subset of colors that the printing device or the printing technology can produce.

“Color transformation” refers to the process of translating a print job (or a portion thereof) that is represented in an input color space to an output. In conventional systems, a color transformation converts each input color space for a print job, on a color by color basis, into an output color space using mathematical algorithms represented by two color profiles: the first color profile converts an input color space to a standardized color space, and the second color profile converts the standardized color space to an output color space. In embodiments described further in this disclosure, the second color profile may be replaced with a color gamut error profile which converts the standardized color space to a scalar value or a vector representing an amount by which a color is out-of-gamut. The mathematical algorithms of the color profiles for a color transformation may be convolved to produce a single mathematical algorithm to increase efficiency.

The present disclosure pertains to methods and systems for automatically routing color print jobs among printing devices that utilize a variety of printing technologies, including high fidelity printing technologies. As such, a print job and or at least one page of a print job may automatically be routed to a printing device based on whether the printing device provides, for example, increased quality for the print job (or at least one page of the print job). For example, only print jobs (or at least one page of a print job) that gain a benefit from being printed by a printing device that utilizes a high fidelity printing technology may be routed to such a printing device. Other print jobs (or at least one page of a print job) may be routed to other printing devices, including printing devices that utilize alternate high fidelity printing technologies and/or other printing technologies.

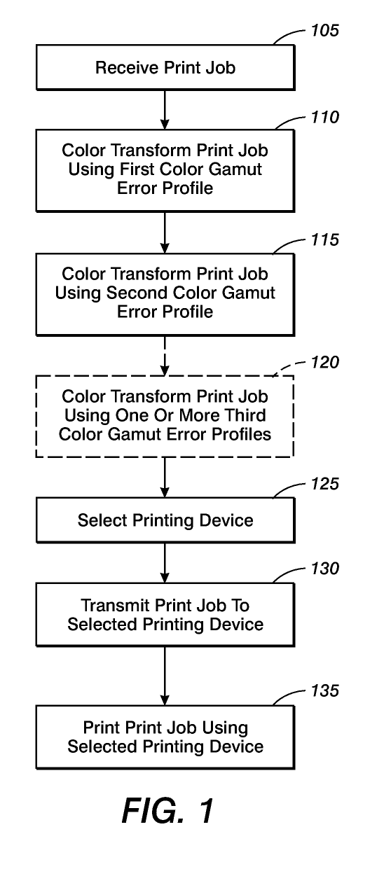

FIG. 1 depicts a flow diagram for an exemplary method of selecting a printing device for a print job according to an embodiment. As shown in FIG. 1, a print job may be received 105. In an embodiment, the print job may be received 105 by a computing device that performs load balancing and routing, such as the FreeFlow Output Manager® from Xerox Corporation.

The computing device may be used to produce 110 a first color transformation for the print job using at least a color gamut error profile for a first printing device. A first value may be determined as a result of the color transformation 110. If a first color cannot be reproduced by the first printing device, a determination of how inaccurate the rendering of the first color would be using the first printing device may be performed. For example, a ΔE color difference measure may be determined for the first color. ΔE is a color difference measure known to those of skill in the art. Additional or alternate difference measures may be used within the scope of this disclosure.

In an embodiment, a determination for a color may result in a scalar value that is proportional to the amount by which the color is out-of-gamut. In an embodiment, the scalar value for a particular color may be set to 0 if the color is in gamut and to a value greater than 0 if the color is out-of-gamut. As such, a color gamut may be inferred from the color gamut error profile because the color gamut may include all values for which the scalar value is 0. If the scalar value for a color is non-zero, the scalar value may be proportional to the amount by which the color is out-of-gamut. In an embodiment, the scalar value may represent a distance measure based on a vector between, for example, a gamut boundary and the color. In an embodiment, scalar values for one or more colors may be aggregated to provide the first value.

In an embodiment, determinations may be performed on a color-by-color basis. Determinations may be performed by identifying a set of colors that are present in a print job and evaluating each color using the color gamut error profile for the first printing device. The first value may be determined based on an aggregate inaccuracy of color rendering based on the color gamut error profile for the first printing device.

The computing device may be used to produce 115 a second color transformation for the print job using at least a color gamut error profile for a second printing device. A second value may be determined as a result of the color transformation 115. The color transformation for the second printing device may be produced 115 in a manner that is similar to producing 110 the color transformation for the first printing device. The second value may be determined based on an aggregate inaccuracy of color rendering based on the color gamut error profile for the second printing device.

In an embodiment, the printing technology corresponding to the first printing device may include a first number of colors (i.e., inks or toners). For example, the printing technology corresponding to the first printing device may be a 4 color printing technology. In an alternate embodiment, the printing technology corresponding to the first printing device may be a high fidelity color printing technology.

Likewise, the printing technology corresponding to the second printing device may include a second number of colors. For example, the printing technology corresponding to the second printing device may be a 6 color printing technology. In an alternate embodiment, the printing technology corresponding to the second printing device may be a 4 color printing technology or a different high fidelity color printing technology.

In an embodiment, the printing technologies corresponding to the first and second printing devices may have the same number of colors. In an alternate embodiment, the printing technologies corresponding to the first and second printing devices may have differing numbers of colors.

In an embodiment, the computing device may additionally be used to produce 120 one or more third color transformations for the print job using one or more color gamut error profiles corresponding to one or more respective third printing devices. A third value may be determined for each third device as a result of a color transformation 120. A color transformation for a third printing device may be produced 120 in a manner that is similar to producing 110 the color transformation for the first printing device. Each third value may be determined based on an aggregate inaccuracy of color rendering based on the color gamut error profile for the respective third printing device.

A printing device may be selected 125 for the print job based on at least the first value and the second value. In an embodiment, the printing device may be selected 125 for the print job by the computing device. In an embodiment, selecting 125 a printing device may be performed by selecting the first printing device if a difference between the first value and the second value is less than a threshold value. Conversely, the second printing device may be selected 125 if the difference between the first value and the second value is not less than the threshold value. In an embodiment, a print shop operator may configure the threshold value. The threshold value may be used, for example, to enable the use of a less costly printing technology if the inaccuracy of the color rendering that will be produced using the less costly printing technology is better or only marginally worse that the inaccuracy of the color rendering produced using a more costly printing technology. Alternate methods of selecting 125 a printing device are included within the scope of this disclosure.

In an embodiment, selecting 125 the printing device may be based on at least the first value, the second value and the one or more third values if color transformations are produced 120 for one or more third devices. In such an embodiment, one or more threshold values may be used to determine which printing device is selected 125.

The print job may be transmitted 130 to the selected printing device. As a result, the print job may be printed 135 on a printing device that provides a benefit, such as higher quality print production, lower cost and/or lower resource usage, to the print shop and/or the customer.

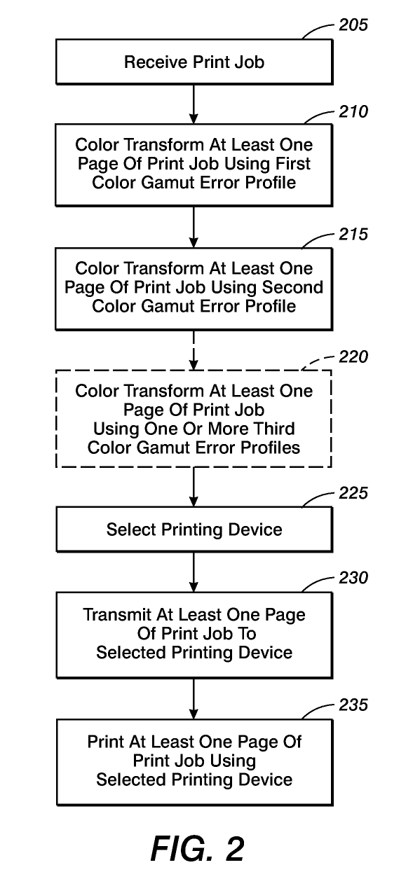

FIG. 2 depicts a flow diagram for an exemplary method of selecting a printing device for at least one page of a print job according to an embodiment. As shown in FIG. 2, a print job may be received 205. In an embodiment, the print job may be received 205 at a computing device that performs load balancing and routing.

The computing device may be used to produce 210 a first color transformation for at least one page using at least a color gamut error profile for a first printing device. A first value may be determined as a result of the color transformation 210. If a first color cannot be reproduced by the first printing device, a determination of how inaccurate the rendering of the first color would be using the first printing device may be performed. For example, a ΔE color difference measure may be determined for the first color. Additional or alternate difference measures may be used within the scope of this disclosure.

In an embodiment, a determination for a color may result in a scalar value that is proportional to the amount by which the color is out-of-gamut. In an embodiment, the scalar value for a particular color may be set to 0 if the color is in gamut and to a value greater than 0 if the color is out-of-gamut. As such, a color gamut may be inferred from the color gamut error profile because the color gamut may include all values for which the scalar value is 0. If the scalar value for a color is non-zero, the scalar value may be proportional to the amount by which the color is out-of-gamut. In an embodiment, the scalar value may represent a distance measure based on a vector between, for example, a gamut boundary and the color. In an embodiment, scalar values for one or more colors may be aggregated to provide the first value.

In an embodiment, determinations may be performed on a color-by-color basis. Determinations may be performed by identifying a set of colors that are present in the at least one page and evaluating each color using the color gamut error profile for the first printing device. The first value may be determined based on an aggregate inaccuracy of color rendering based on the color gamut error profile for the first printing device.

The computing device may be used to produce 215 a second color transformation for the at least one page using at least a color gamut error profile for a second printing device. A second value may be determined as a result of the color transformation 215. The color transformation for the second printing device may be produced 215 in a manner that is similar to producing 210 the color transformation for the first printing device. The second value may be determined based on an aggregate inaccuracy of color rendering based on the color gamut error profile for the second printing device.

In an embodiment, the printing technology corresponding to the first printing device may include a first number of colors (i.e., inks or toners). For example, the printing technology corresponding to the first printing device may be a 4 color printing technology. In an alternate embodiment, the printing technology corresponding to the first printing device may be a high fidelity color printing technology.

Likewise, the printing technology corresponding to the second printing device may include a second number of colors. For example, the printing technology corresponding to the second printing device may be a 6 color printing technology. In an alternate embodiment, the printing technology corresponding to the second printing device may be a 4 color printing technology or a different high fidelity color printing technology.

In an embodiment, the printing technologies corresponding to the first and second printing devices may have the same number of colors. In an alternate embodiment, the printing technologies corresponding to the first and second printing devices may have differing numbers of colors.

In an embodiment, the computing device may additionally be used to produce 220 one or more third color transformations for the at least one page using one or more color gamut error profiles corresponding to one or more respective third printing devices. A third value may be determined for each third device as a result of a color transformation 220. A color transformation for a third printing device may be produced 220 in a manner that is similar to producing 210 the color transformation for the first printing device. Each third value may be determined based on an aggregate inaccuracy of color rendering based on the color gamut error profile for a third printing device.

A printing device may be selected 225 for the at least one page based on at least the first value and the second value. In an embodiment, the printing device may be selected 225 for the at least one page by the computing device. In an embodiment, selecting 225 a printing device may be performed by selecting the first printing device if a difference between the first value and the second value is less than a threshold value. Conversely, the second printing device may be selected 225 if the difference between the first value and the second value is not less than a threshold value. In an embodiment, a print shop operator may configure the threshold value. The threshold value may be used, for example, to enable the use of a less costly printing technology if the inaccuracy of the color rendering that will be produced using the less costly printing technology is better or only marginally worse that the inaccuracy of the color rendering produced using a more costly printing technology. Alternate methods of selecting 225 a printing device are included within the scope of this disclosure.

In an embodiment, selecting 225 the printing device may be based on at least the first value, the second value and one or more third values if color transformations are produced 220 for one or more third devices. In such an embodiment, one or more threshold values may be used to determine which printing device is selected 225.

The at least one page of the print job may be transmitted 230 to the selected printing device. As a result, the at least one page of the print job may be printed 235 on a printing device that provides a benefit, such as higher quality print production, lower cost and/or lower resource usage, to the print shop and/or the customer.

In an embodiment, a print job having a plurality of pages may have at least one page transmitted 230 to and printed 235 on a first printing device and at least one other page transmitted and printed on a second printing device. For example, a subset of pages containing color photographs may be printed 235 on a printing device having a high fidelity printing technology while other pages may be printed on another printing device.

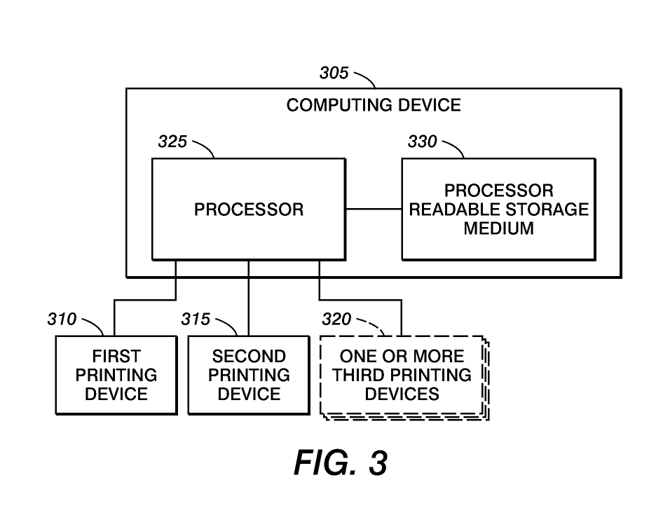

FIG. 3 depicts a block diagram of an exemplary system for selecting a printing device for a print job or at least one page of a print job according to an embodiment. As shown in FIG. 3, the system may include a computing device 305, a first printing device 310, and a second printing device 315. In an embodiment, the system may further include one or more third printing devices 320. The computing device 305 may include a processor 325 and a processor readable storage medium 330 in communication with the processor. The processor 325 may be used to perform one or more operations for selecting a printing device. The processor readable storage medium 330 may include programming instructions that, when executed by the processor 325, may perform operations for selecting a printing device, such as those listed above in reference to FIGS. 1 and 2. In an embodiment, the processor-readable storage medium 330 may further contain color gamut error profiles for the first printing device 310, the second printing device 315 and, if used, the one or more third printing devices 320.

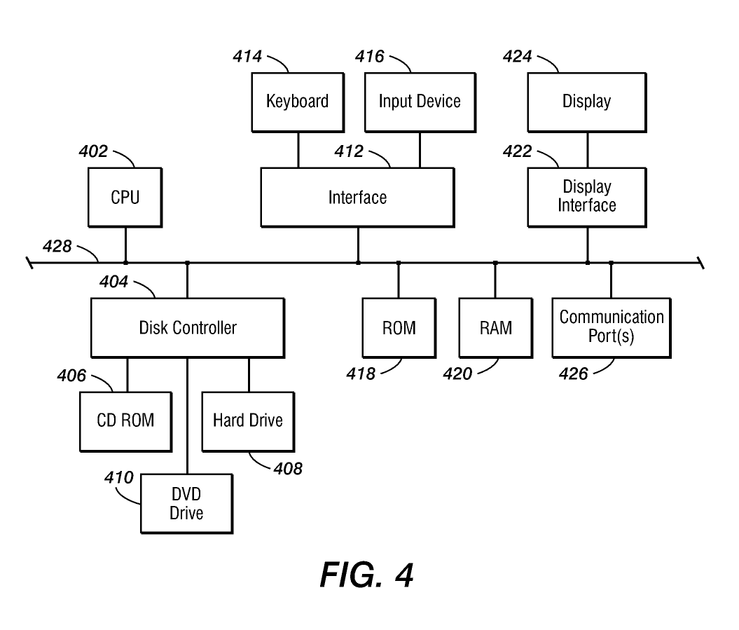

FIG. 4 depicts a block diagram of an exemplary system that may be used to contain or implement program instructions for selecting a printing device for a print job or at least one page of a print job according to an embodiment. Referring to FIG. 4, a bus 428 serves as the main information highway interconnecting the other illustrated components of the hardware. CPU 402 is the central processing unit of the system, performing calculations and logic operations required to execute a program. Read only memory (ROM) 418 and random access memory (RAM) 420 constitute exemplary memory devices or storage media.

A disk controller 404 interfaces with one or more optional disk drives to the system bus 428. These disk drives may include, for example, external or internal DVD drives 410, CD ROM drives 406 or hard drives 408. As indicated previously, these various disk drives and disk controllers are optional devices.

Program instructions may be stored in the ROM 418 and/or the RAM 420. Optionally, program instructions may be stored on any other tangible computer readable storage medium, such as a hard drive, a compact disk, a digital disk, a memory or any other tangible recording medium.

An optional display interface 422 may permit information from the bus 428 to be displayed on the display 424 in audio, graphic or alphanumeric format. Communication with external devices may occur using various communication ports 426.

In addition to the standard computer-type components, the hardware may also include an interface 412 which allows for receipt of data from input devices such as a keyboard 414 or other input device 416 such as a mouse, remote control, pointer and/or joystick.

An embedded system may optionally be used to perform one, some or all of the operations described herein. Likewise, a multiprocessor system may optionally be used to perform one, some or all of the operations described herein.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the disclosed embodiments.

What is claimed is:

1. A method of selecting a printing device, the method comprising:
receiving a print job;
producing, by a computing device, a first color transformation for the print job using at least a color gamut error profile for a first printing device to determine a first value;
producing, by the computing device, a second color transformation for the print job using at least a color gamut error profile for a second printing device to determine a second value;
selecting one of the printing devices for the print job based on at least the first value and the second value;
transmitting the print job to the selected printing device; and
printing the print job using the selected printing device.

2. The method of claim 1 wherein producing a first color transformation comprises producing a first color transformation for the print job using at least a color gamut error profile representing a first printing technology having a first number of colors, and wherein producing a second color transformation comprises producing a second color transformation for the print job using at least a color gamut error profile representing a second printing technology having a second number of colors, wherein the first number of colors differs from the second number of colors.

3. The method of claim 1 wherein selecting one of the printing devices comprises selecting, by the computing device, one of the printing devices for the print job based on at least the first value and the second value.

4. The method of claim 1 wherein selecting one of the printing devices comprises:
selecting the first printing device if the difference between the first value and the second value is less than a threshold; and
selecting the second printing device if the difference between the first value and the second value is not less than the threshold.

5. The method of claim 1, further comprising:
producing, by the computing device, one or more color transformations for the print job using at least a color gamut error profile for one or more third printing devices to determine a third value for each third printing device, and
wherein selecting one of the printing devices is further based on at least the one or more third values.

6. A system for selecting a printing device, the system comprising:
a first printing device;
a second printing device;
a processor in communication with the first printing device and the second printing device; and
a processor readable storage medium in communication with the processor,
wherein the processor readable storage medium contains one or more programming instructions for:
receiving a print job,
producing, by the processor, a first color transformation for the print job using at least a color gamut error profile for the first printing device to determine a first value,
producing, by the processor, a second color transformation for the print job using at least a color gamut error profile for the second printing device to determine a second value,
selecting one of the printing devices for the print job based on at least the first value and the second value, and
transmitting the print job to the selected printing device.

7. The system of claim 6 wherein the first printing device comprises a printing device having a first number of colors and the second printing device comprises a printing device having a second number of colors, wherein the first number of colors differs from the second number of colors.

8. The system of claim 6 wherein the one or more programming instructions for selecting one of the printing devices comprise one or more programming instructions for:
selecting the first printing device if the difference between the first value and the second value is less than a threshold; and
selecting the second printing device if the difference between the first value and the second value is not less than the threshold.

9. The system of claim 6, further comprising:
one or more third printing devices, wherein each third printing device is in communication with the processor,
wherein the one or more programming instructions further comprise producing, by the processor, one or more third color transformations for the print job using at least a color gamut error profile for each third printing device to determine a third value for each third printing device, and
wherein the one or more programming instructions for selecting one of the printing devices comprise one or more programming instructions for selecting one of the printing devices for the print job based on at least the first value, the second value and the one or more third values.

10. A method of selecting a printing device, the method comprising:
receiving a print job; and
for at least one page of the print job:
producing, by a computing device, a first color transformation for the at least one page using at least a color gamut error profile for the first printing device to determine a first value,
producing, by the computing device, a second color transformation for the at least one page using at least a color gamut error profile for the second printing device to determine a second value,
selecting one of the printing devices for the at least one page based on at least the first value and the second value,
transmitting the at least one page to the selected printing device; and
printing the at least one page using the selected printing device.

11. The method of claim 10 wherein producing a first color transformation comprises producing a first color transformation for the at least one page using at least a color gamut error profile representing a first printing technology having a first number of colors, and wherein producing a second color transformation comprises producing a second color transformation for the at least one page using at least a color gamut error profile representing a second printing technology having a second number of colors, wherein the first number of colors differs from the second number of colors.

12. The method of claim 10 wherein selecting one of the printing devices comprises selecting, by the computing device, one of the printing devices for the at least one page based on at least the first value and the second value.

13. The method of claim 10 wherein selecting one of the printing devices comprises:
selecting the first printing device if the difference between the first value and the second value is less than a threshold; and
selecting the second printing device if the difference between the first value and the second value is not less than the threshold.

14. The method of claim 10, further comprising.
producing, by the computing device, one or more color transformations for the at least one page using at least a color gamut error profile for one or more third printing devices to determine a third value for each third printing device, and
wherein selecting one of the printing devices is further based on at least the one or more third values.

15. A system for selecting a printing device, the system comprising:
a first printing device;
a second printing device,
a processor in communication with the first printing device and the second printing device; and
a processor readable storage medium in communication with the processor;
wherein the processor readable storage medium contains one or more programming instructions for:
receiving a print job, and
for at least one page of the print job:
producing, by the processor, a first color transformation for the at least one page using at least a color gamut error profile for the first printing device to determine a first value,
producing, by the processor, a second color transformation for the at least one page using at least a color gamut error profile for the second printing device to determine a second value,
selecting one of the printing devices for the at least one page based on at least the first value and the second value, and
transmitting the at least one page to the selected printing device.

16. The system of claim 15 wherein the first printing device comprises a printing device having a first number of colors and the second printing device comprises a printing device having a second number of colors, wherein the first number of colors differs from the second number of colors.

17. The system of claim 15 wherein the one or more programming instructions for selecting one of the printing devices comprise one or more programming instructions for:
selecting the first printing device if the difference between the first value and the second value is less than a threshold; and
selecting the second printing device if the difference between the first value and the second value is not less than the threshold.

18. The system of claim 15, further comprising:
one or more third printing devices, wherein each third printing device is in communication with the processor,
wherein the one or more programming instructions further comprise, for at least one page of the print job, producing, by the processor, one or more third color transformations for the at least one page using at least a color gamut error profile for each third printing device to determine a third value, and
wherein the one or more programming instructions for selecting one of the printing devices comprise one or more programming instructions for selecting one of the printing devices for the at least one page based on at least the first value, the second value and the one or more third values.
